(19) United States
(12) Patent Application Publication
(10) Pub. No.: US 2005/0249645 A1
(43) Pub. Date: Nov. 10, 2005

(54) Catalyst and adsorbant bed configurations suitable for mobile applications

(75) Inventors: Wayne Scott Kaboord, Mequon, WI (US); Dawn Marie Becher, Random Lake, WI (US); Fred Joseph Begale, Oconomowoc, WI (US); John Albert Kovacich, Waukesha, WI (US)

Correspondence Address: PAUL V. KELLER, LLC, 4585 LIBERTY RD., SOUTH EUCLID, OH, 44121, US

(73) Assignee: Eaton Corporation, Cleveland, OH (US)

(21) Appl. No.: 10/839,567

(22) Filed: May 5, 2004

(51) Int. Cl. B01D 53/34

(52) U.S. Cl. 422/177; 422/171; 422/173

(57) ABSTRACT

The present invention provides adsorbers with a high spatial and/or mass density of usable adsorbant in configuration suitable for vehicle exhaust systems. One aspect of the invention relates to an adsorber or catalyst having a monolith structure and porous walls. The walls have a void volume of at least about 0.1 exclusive of pores having a diameter less the 1 μm. Another aspect of the invention relates to an adsorber or catalyst having a bed comprising porous pellets fused together to form a cohesive mass. A further aspect of the invention relates to an adsorber or catalyst having a bed comprising coated wire screens. A still further aspect of the invention relates to an adsorber or catalyst having a small number of channels, preferably just one central channel, for heating and cooling.

### FIELD OF THE INVENTION

The present invention relates to the field of pollution control devices for internal combustion engines.

### BACKGROUND OF THE INVENTION

Structured catalysts for vehicle exhaust emission controls have been widely used since the 1970s. Early catalysts were provided in packed beds, but packed beds have long since been replace by monoliths. Monoliths comprise honeycombs and other arrays of parallel passages that provide good contacting between exhaust and catalyst coatings while limiting back pressure on engines. Nearly every gasoline powered vehicle manufactured today has a three-way catalyst provided on a monolith support.

While adsorbers are not in such broad use, they have long been studied in connection with NOx emissions from diesel engines and lean-burn gasoline engines. Several countries, including the United States, have long had regulations pending that will limit NOₓ emissions in diesel exhaust. The exhaust of diesel powered vehicles and vehicles with lean-burn gasoline engines is too oxygen-rich for three-way catalysts. Instead, several different approaches have been suggested for controlling NOx emissions from diesel and lean burn engines. One of the more promising of those approaches involves the use of NOₓ adsorber-catalysts.

NOx adsorber-catalysts alternately adsorb NOx and catalytically reduce it. The adsorber can be taken offline during regeneration. The adsorbant is generally an alkaline earth oxide adsorbant, such as BaCO₃ and the catalyst can be a precious metal, such as Ru. In the prior art, the preferred structure for an adsober used to treat vehicle exhaust is almost always a monolith.

U.S. Appl. No. 2003/0177763 describes an adsorber-catalyst that is periodically regenerated with CO. The suggested structure for the adsorber is a monolith.

U.S. Pat. No. 5,125,231 describes an adsorber-catalyst used in conjunction with a catalytic converter to reduce cold start hydrocarbon emissions. The adsorber is optionally a monolith or a packed bed.

U.S. Pat. No. 5,587,137 describes an exhaust system with a zeolite adsorbant and a catalyst placed in line. The zeolite adsorbant is meant to be active during cold start. The description allows that “the zeolite can be in powder form, self-supporting geometric shapes as bead, or pellet, monolith, eg., extruded honeycombs, etc, or be in contact with a substrate, preferably a honeycomb substrate.”

U.S. Pat. No. 5,910,097 describes an exhaust emission control system with two NOx adsorbers in parallel. While one adsorber is treating the exhaust, the other is being regenerated. Regeneration involves inducing desorption and recirculating the desorbed gases through the engine. The internal structure of the adsorbers is not mentioned, but the drawings suggest pellet beds.

There continues to be a long felt need for reliable, affordable, and effective adsorbers that are suitable for mobile applications.

### SUMMARY OF THE INVENTION

The following presents a simplified summary in order to provide a basic understanding of some aspects of the invention. This summary is not an extensive overview of the invention. It is intended neither to identify key or critical elements of the invention nor to delineate the scope of the invention. Rather, the primary purpose of this summary is to present some concepts of the invention in a simplified form as a prelude to the more detailed description that is presented later.

One aspect of the invention relates to an adsorber or catalyst suitable for use in a vehicle exhaust system having a monolith structure and porous walls. The walls have a void volume of at least about 0.1 exclusive of pores having a diameter less the 1 μm. Preferably, the walls comprises at least about 40% a molecular sieve by weight. The wall porosity can be achieved by forming the monolith out of fused pellets. The monolith has the pressure drop and mass transfer characteristics of a conventional monolith, while allowing a greater amount of microporous adsorbant to be effectively used.

Another aspect of the invention relates to an adsorber or catalyst suitable for use in a vehicle exhaust system having a bed comprising porous pellets fused together to form a cohesive mass wherein the bulk of the gas entering the bed must pass through intersticies between the pellets to reach an exit port. Preferably, the pellets comprise at least about 40% a molecular sieve by weight and have a void volume of at least about 0.1 exclusive of pores having a diameter less the 1 μm. The porosity associated with larger pores in the pellets greatly increases their surface area exclusive of surfaces only accessible through small diameter pores. Fusing the pellets into a cohesive mass greatly reduces the tendency of the pellets to erode under vibration.

A further aspect of the invention relates to an adsorber or catalyst suitable for use in a vehicle exhaust system having a bed comprising coated layered screening. Gas flows between adjacent layers of the screening and the adsorbant can form a relatively thick coating on the screening. Preferably, the bed comprises at least about 40% a molecular sieve by weight.

A still further aspect of the invention relates to an adsorber or catalyst suitable for use in a vehicle exhaust system having an adaptation for heating or cooling. An entrance port and an exit port are configured with respect to an adsorber or catalyst bed such that gas traveling between the ports is channeled through the bed. One or more separate channels passes through the bed while in fluid isolation from the bed. The channels individually having a cross-sectional area of at least about 1 square inch. There are only a few channels, preferably only one. The one channel preferably passes through the center of the bed. The channels provide a simple way of heating or cooling the bed using exhaust or ambient air.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is an illustration of an adsorber comprising a porous-walled monolith;

FIG. 2 is an illustration of an adsorber comprising a cohesive mass of adsorbant pellets;

FIG. 3 is an illustration of an adsorber comprising a stack of coated screens;

FIG. 4 is a cross-sectional view of the adsorber of FIG. 3;

FIG. 5 is an illustration of an adsorber comprising an annular monolith adsorbant bed and a central channel for heat exchange;

FIG. 6 is a cross-sectional view of the adsorber of FIG. 5;

FIG. 7 is another cross-sectional view of the adsorber of FIG. 5;

FIG. 8 is an illustration of an adsorber comprising a rolled, coated screen adsorbant bed surrounding a central channel for heat exchange;

FIG. 9 is a cross-sectional view of the adsorber of FIG. 8;

FIG. 10 is an illustration of an adsorber comprising coated screens radially arrayed around a central channel; and

FIG. 11 is a cross-sectional view of the adsorber of FIG. 10.

### DETAILED DESCRIPTION OF THE INVENTION

The invention is specifically applicable to vehicle exhaust systems. Vehicle exhaust systems create restriction on weight, dimensions, and durability. For example, an adsorber or a catalyst bed for a vehicle exhaust systems must be reasonably resistant to degradation under the vibrations encountered during vehicle operation. A vehicle is typically powered by an internal combustion engine burning a fuel such as diesel, gasoline, natural gas, or propane and produces an exhaust.

While other compounds may be targeted, adsorbates of primary concern are NOx and NH₃. NOₓ includes, without limitation, NO, NO₂, N₂O, and N₂O₂. NOx adsorption is of interest in connection with removing NOx from exhaust. NH₃ adsorption is of interest as a means of safely storing NH₃ for use in selective catalytic reduction (SCR) of NOx. Adsorbers according to the invention may be used to extract or store other compounds as well.

The present invention is primarily directed to adsorbers, although the structures may also be useful as catalyst beds. Prior art designs for adsorbers are generally adapted from catalyst bed designs. In catalyst beds, the catalyst is typically distributed in a relatively thin washcoat over an inert substrate. The present invention improves over adsorption beds based on catalyst bed designs by providing more useful adsorbant per unit bed mass.

Preferably, an adsorbant bed according to the present invention comprises at least about 40% adsorbant by weight, more preferably at least about 60%, still more preferably at least about 80%, and most preferably at least about 90%. The weight of an adsorbant bed includes any inert substrate and any binders, but does not include any housing.

Adsorbant beds according to the invention generally carry more adsorbant per unit volume than prior art beds. In one embodiment, an adsorbant bed according to the invention is at least about 20% adsorbant by volume, in another embodiment, at least about 35% adsorbant by volume, in a further embodiment, at least about 50% adsorbant by volume, and in a still further embodiment, at least about 65% adsorbant by volume. The highest adsorbant densities are of particular interest for applications like NH₃ storage where pressure drop is generally less of a concern as compared to applications where the adsorber is to be placed in the main exhaust flow.

Adsorbers according to the present invention are commonly provided with mechanisms for heating and/or cooling in contemplation of temperature swing adsorption. For example, an adsorption bed can be permeated with heat-exchange passages in fluid isolation from the passages provided for adsorbed and desorbed gases. A hot or cold fluid is circulated through the heat-exchange passages to heat or cool the adsorber. A cooling fluid could be, for example, engine coolant or ambient air. A heating fluid could be, for example, hot exhaust or a fluid that draws heat from hot exhaust or a heat-producing device such as an ammonia synthesis reactor, a catalytic reformer, or an adsorber.

In one embodiment of the invention, the adsorber has a small number of heat-exchange passages, for example less than five, and preferably just one. A single channel can pass through the center of the adsorber. A central channel is typically rather large, having for example a cross-sectional area of at least about 1 square inch. The channels can be provided with heat exchanger fins. Advantages of heat exchange through a single central passage include simplicity and low pressure drop. The design takes advantage of the fact that larger variations in temperature are generally permissible in adsorption beds than in catalyst beds.

An adsorber can also include a provision for electrical heating. Where the adsorber includes a metal substrate, the metal substrate can be used as an electrical resistance heater. An adsorption bed can also be permeated by wires for electrical resistance heating.

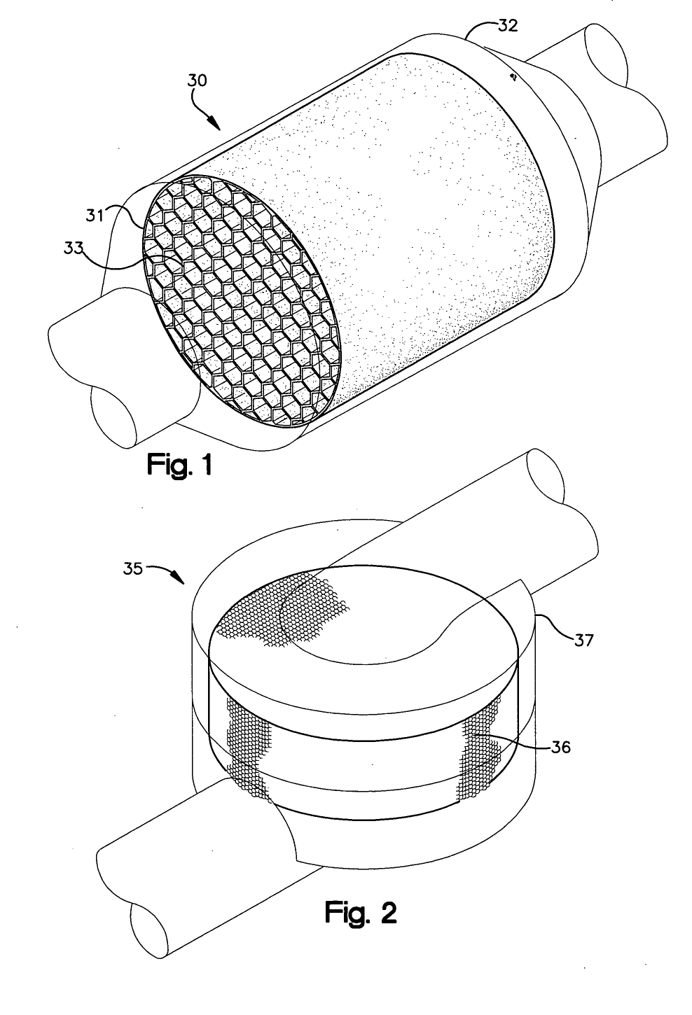

FIG. 1 illustrates an adsorber 30 with a design for improving the utilization of an adsorbant, especially a molecular sieve adsorbant that has very small pores. The adsorber 30 comprises a monolith 31 within a housing 32. The monolith 31 is preferably a self-supporting structure without an inert substrate. The monolith can be cast or extruded. Casting may be accomplished by pressing a coarse mixture of adsorbant pellets and binder into a mold and then curing the mixture. Alternately, the pellets can be pored into the mold and sintered to form a cohesive mass. Extrusion can be carried out in a similar fashion with heat applied at the point of extrusion to cure the binder or sinter the pellets. The pellets themselves are typically a mixture of adsorbant and binder. The walls 33 of the monolith 31 have a macro-porous structure, whereby the diffusion path length from the macro-pores to the innermost parts of the walls 33 is substantially less than the diffusion path length from the channels to the centers of the walls. Because the monolith 31 lacks an inert substrate, it comprises a large fraction of adsorbant by weight. Preferably, the walls of the monolith, exclusive of the channel volume and exclusive of any pores having an effective diameter less than 1 μm (an effective diameter being defined with reference to mercury porosimetry) have a void volume fraction of at least about 0.1, more preferably at least about 0.2, still more preferably at least about 0.3.

FIG. 2 illustrates an adsorber 35 comprising a cohesive mass of pellets 36 in a housing 37. Loose pellets in a packed bed have a tendency to erode when mounted on a vehicle. The adsorber 35 mitigates this problem by forming the pellets into a cohesive mass. The pellets can be formed into a cohesive mass by, for example, sintering the pellets together or mixing them with a binder. The individual pellets are preferably themselves made up of smaller pellets. Smaller pellets can themselves be formed onto larger pellets by a binder or a sintering process. The intersticies between the larger pellets correspond to the channels of the monolith 31 and the voids in the pellets (intersticies between the smaller pellets, where appropriate) correspond to the voids in the walls of the monolith 31. The comments regarding preferred composition and void sizes for the monolith 31 apply to the cohesive mass 36. The adsorber 35 is provided in a pancake design. A pancake design gives a large cross-sectional area in the direction of flow and thereby reduces the pressure drop for a given bed volume.

The packed bed designs of the present invention can provide very high adsorbant densities. Density can be increased by using a mixture of pellet sizes, for example, a mixture of 1/16 inch and 1/8 inch pellets.

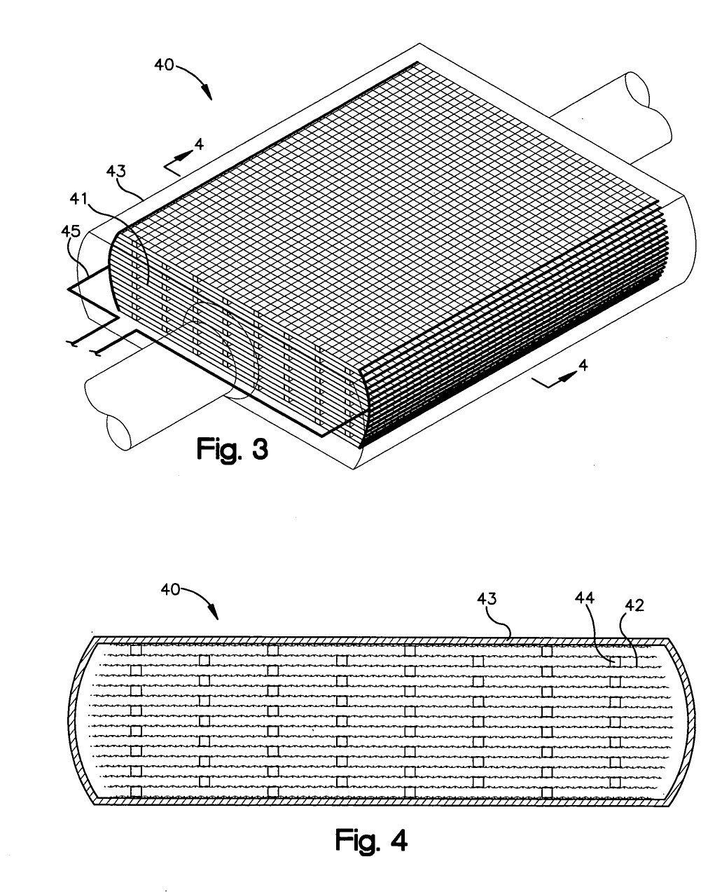

FIGS. 3 and 4 illustrates a device 40 in the form of a stack 41 of coated metal screens 42 in a housing 43. An adsorbant or catalyst forms a coating over the screens 42. Exhaust flows between the screens 42. The spacing between the screens is controlled by spacers 44. The openings in the screens 42 provide additional surface area for the adsorbant. Optional electrical leads 45 are connected to the screens along either side of the adsorbent bed. By connecting a power source to the electrical leads 45, the device 40 can be heated.

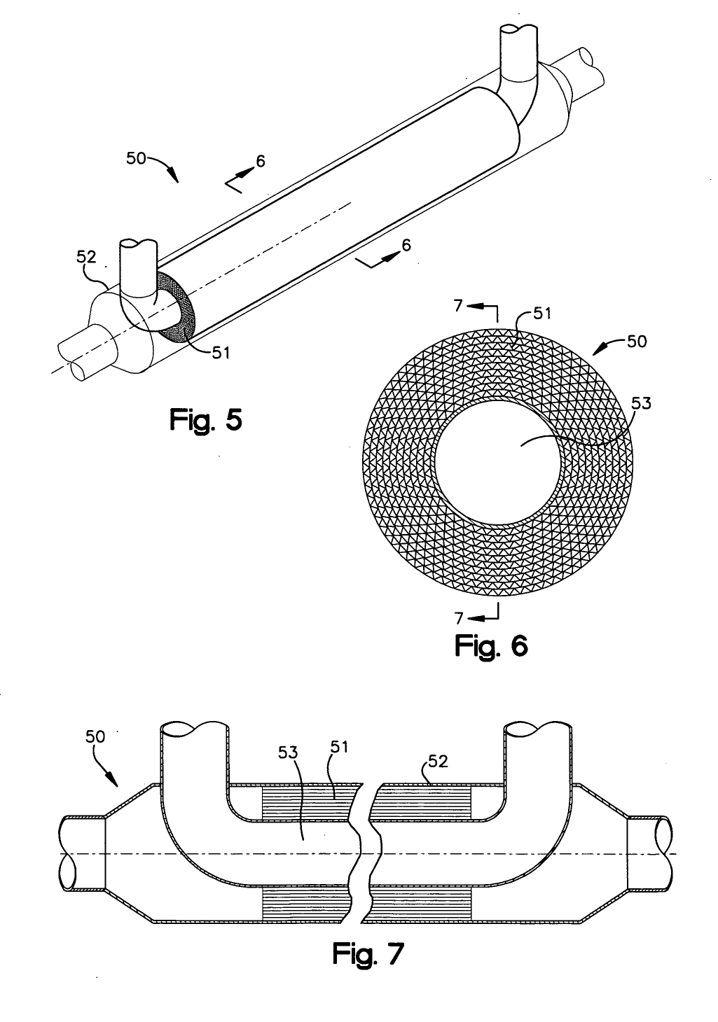

FIGS. 5 to 7 illustrate a device 50 comprising an annular monolith 51 enclosed in a housing 52 and surrounding a central channel 53. The central channel 53 is in fluid isolation from the monolith 51, but can be used to heat or cool the monolith. For example, the monolith can be heated by passing hot exhaust through the central channel 51 and cooled by driving ambient air through the central channel 51. The monolith itself can have any suitable structure. In one embodiment, the monolith is made up of metal foil coated with an adsorbant or catalyst. The structure can be made by spiraling together two rolled sheets of metal, one flat and one articulated, about the central channel. A metal foil substrate can be used for electrical resistance heating. The catalyst or adsorbent bed occupying the annular region can alternatively be, for example, a cohesive mass of pellets or layered coated screening.

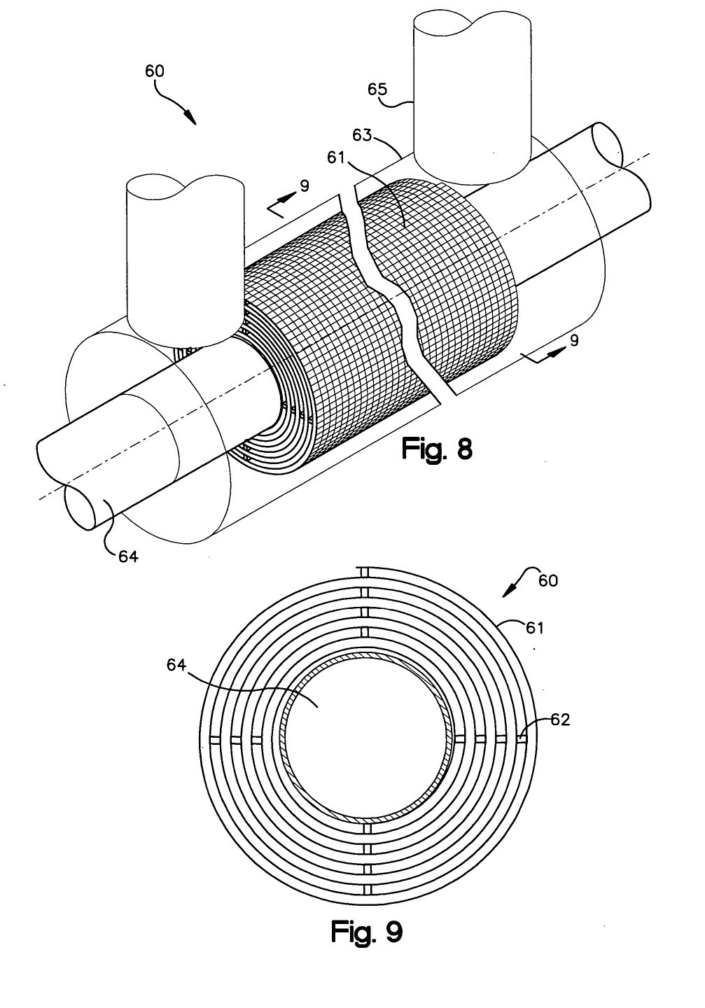

FIGS. 8 and 9 illustrate an adsorber 60 that has a housing 63 and a central channel 64. The adsorbent bed 61 comprises a metal screen coated with adsorbant or catalyst and rolled into a hollow cylinder to form roughly annular passages. The widths of the passages are controlled by spacers 62. The housing 63 is different from the housing 53 of the adsorber 50 in that the central passage vents out the ends rather than the sides. These housings can be interchanged.

The housing 52 and 63 and their associated beds and central channels can have any appropriate dimensions for a particular application. The length, central channel diameter, and bed outer diameter are selected in view of the required volume, bed thermal conductivity, requirements for temperature uniformity, requirements for heat exchange, and limitations on pressure drops through the bed and central channel. Mathematical calculations and/or computer simulations can be used to identify appropriate designs for particular applications. The frontal area of the bed and channel is typically from about 4 square inches to about 120 square inches, more typically from about 7 square inches to about 50 square inches. The inner channel diameter is typically from about 1 to about 3 inches. The difference between the inner and the outer channel diameter is typically from about 1 to about 3 inches. The length to outer diameter ratio is typically from about 12:1 to about 3:1.

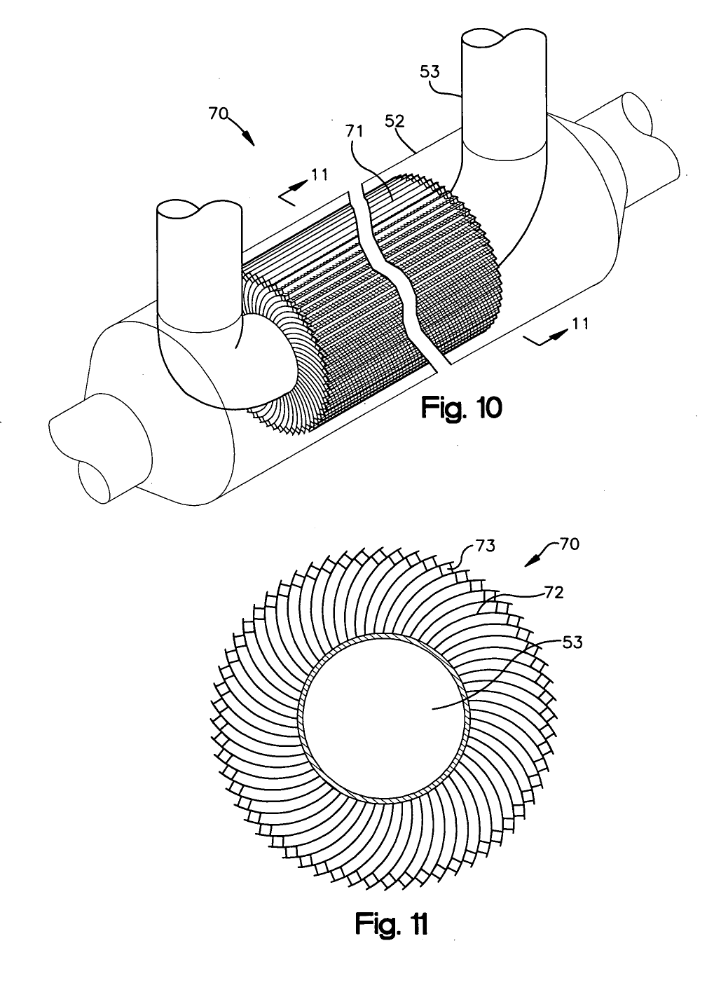

FIGS. 10 and 11 illustrate an adsorber 70 using the housing 52 and the central channel 53. The adsorber 70 comprises an adsorbant bed 71 made of metal screens 72 coated with adsorbant or catalyst, attached edgewise, and arrayed radially about the central channel 53. Attaching the screens 72 edgewise to the central channel 53 may facilitate heat transfer between the adsorbant bed 71 and the central channel 53. Optionally, the central channel 53 includes heat-exchanger fins extending from the edges of the channel towards its interior. The screens 72 curve as they extend away from the central channel 53. The curvature limits or eliminates the tendency for the spacing between screens 72 to increase with distance from the central channel 53. The curvature also makes the adsorber 70 more compact and may further facilitate heat exchange with a fluid in the central channel 53. The spacing between screens is controlled with spacers 73.

In one embodiment, the adsorbant has a large capacity for adsorbing an NOx species at a typical adsorption temperature and exhaust partial pressures. Preferably, the adsorbant can adsorb at least about 3% of an NOx species by weight adsorbant at a typical adsorption temperature and 1 torr partial pressure of the NOx species, more preferably at least about 5% by weight adsorbant, and still more preferably at least about 7% by weight adsorbant. The weight of adsorbant does not include the weight of any binders or inert substrates.

The weight of adsorbant can be significant. To minimize total weight, the adsorbant preferably accounts for at least about 40% of the adsorber weight, more preferably at least about 60%, and still more preferably at least about 80%. Preferably, an adsorber, or a group of adsorbers provided on a vehicle together, can adsorb at least 250 gm of an NOx species at a typical adsorption temperature and 1 torr partial pressure of the NOx species, more preferably at least about 500 gm, still more preferably at least about 1000 gm.

A typical adsorption temperature depends on the embodiment of the present invention. In one embodiment, the adsorber is cooled with engine coolant and the typical adsorption temperature is 65° C. In another embodiment, the adsorbers is cooled with engine coolant or ambient air, but the exhaust is kept above the condensation temperature of water. In such a case, the typical adsorption temperature is 120° C. In a further embodiment, the adsorber is cooled to about an average exhaust gas temperature, and a typical adsorption temperature is 350° C. Lower temperature operating regimes have the advantage that a greater degree of NOx adsorption can generally be achieved and greater desorption can be achieved with a smaller change in the adsorbant temperature.

The heat (energy) of adsorption is a critical factor in determining the temperature increase that will induce desorption. Solid adsorbants generally have a plurality of types of binding sites with a range of heats of adsorption, but an average or approximate value can be determined by analyzing changes in partial pressure with temperature. A larger heat of adsorption means a more rapid increase in partial pressure of adsorbants with temperature. Preferably, the heat of adsorption for NO on the adsorbant is at least about 50 kJ/mol, more preferably at least about 70 kJ/mol, still more preferably at least about 90 kJ/mol.

Any suitable adsorbant material can be used. Examples of adsorbants are molecular sieves, such as zeolites, alumina, silica, and activated carbon. Further examples are oxides, carbonates, and hydroxides of alkaline earth metals such as Mg, Ca, Sr, and Be or alkali metals such as K or Ce. Still further examples include metal phosphates, such as phoshates of titanium and zirconium.

Molecular seives are materials having a crystalline structure that defines internal cavities and interconnecting pores of regular size. Zeolites are the most common example. Zeolites have crystalline structures generally based on atoms tetrahedrally bonded to each other with oxygen bridges. The atoms are most commonly aluminum and silicon (giving aluminosilicates), but P, Ga, Ge, B, Be, and other atoms can also make up the tetrahedral framework. The properties of a zeolite may be modified by ion exchange, for example with a rare earth metal or chromium. While the selection of an adsorbant depends on such factors as the material to be adsorbed, the desired adsorption temperature, and the desorption method, preferred zeolites generally include faujasites, rare earth zeolites, and Thomsonite. Faujasites include X and Y-type zeolites. Rare earth zeolites are zeolites that have been extensively (i.e., at least about 50%) or fully ion exchanged with a rare earth metal, such as lanthanum.

The adsorbant is typically combined with a binder and either formed into a self-supporting structure or applied as a coating over an inert substrate. A binder can be, for example, a clay, a silicate, or a cement. Generally, the adsorbant is most effective when a minimum of binder is used. Preferably, the adsorbant bed contains from about 3 to about 20% binder, more preferably from about 3 to about 12%, most preferably from about 3 to about 8%. A preferred composition for small adsorbant pellets that can be used to form monoliths, larger pellets, or a porous coatings over an inert substrate such as screening, is molecular sieve crystals with about 8% or less portland cement as a binder. This composition can provide structural integrity and high utilization of the molecular sieve's adsorption capacity.

The invention has been shown and described with respect to certain aspects, examples, and embodiments. While a particular feature of the invention may have been disclosed with respect to only one of several aspects, examples, or embodiments, the feature may be combined with one or more other features of the other aspects, examples, or embodiments as may be advantageous for any given or particular application.

1. A device suitable for use in a vehicle exhaust system, comprising:
an adsorption or catalyst bed comprising pellets fused together to form a cohesive mass; and
an entrance port, an exit port, and a housing configured whereby the bulk of the gas entering the device through the entrance must pass through intersticies between the pellets to reach the exit port.

2. The device of claim 1, wherein the pellets have a void volume of at least about 0.1 exclusive of pores having a diameter less the 1 μm.

3. The device of claim 1, wherein the bed comprises at least about 35% adsorbant by volume.

4. The device of claim 3, wherein the bed comprises at least about 65% adsorbant by volume.

5. The device of claim 3, wherein the adsorbant is a molecular sieve.

6. The device of claim 1, wherein the bed comprises at least about 40% adsorbant by weight.

7. The device of claim 6, wherein the bed comprises at least about 80% adsorbant by weight.

8. The device of claim 6, wherein the adsorbant is a molecular sieve.

9. A vehicle powered by an internal combustion engine comprising the device of claim 1.

10. The device of claim 1, wherein the pellets comprise at least about 70% a molecular sieve by weight and from about 1% to about 20% binder by weight.

11. The device of claim 9, wherein the pellets comprise at least about 80% a molecular sieve by weight and from about 5% to about 12% binder by weight.

12. The device of claim 1, wherein the bed is permeated by metal wires that can be used to electrically heat the bed.

13. The device of claim 1, wherein the bed is permeated by tubes that can be used to heat the bed through fluid heat exchange.

14. The device of claim 1, wherein the pellets have been fused together by sintering.

15. The device of claim 1, wherein the pellets are fused together by a binder.

16. A device suitable for use in a vehicle exhaust system, comprising:
an adsorption or catalyst bed comprising adsorbant or catalyst coated layered screening; and
an entrance port, an exit port, and a housing configured whereby the bulk of the gas entering the device through the entrance passes between adjacent layers of the screening to reach the exit port.

17. The device of claim 16, wherein the bed comprises at least about 35% adsorbant by volume.

18. The device of claim 16, wherein the coating on the screening has a void volume of at least about 0.1 exclusive of pores having a diameter less the 1 μm.

19. The device of claim 16, wherein the bed comprises at least about 50% adsorbant by volume.

20. The device of claim 19, wherein the adsorbant is a molecular sieve.

21. The device of claim 16, wherein the bed comprises at least about 40% adsorbant by weight.

22. The device of claim 21, wherein the bed comprises at least about 60% adsorbant by weight.

23. The device of claim 21, wherein the adsorbant is a molecular sieve.

24. A vehicle powered by an internal combustion engine comprising a device according to claim 16.

25. The device of claim 16, wherein the coating comprises at least about 70% a molecular sieve by weight and from about 1% to about 20% binder by weight.

26. The device of claim 25, wherein the coating comprises at least about 80% a molecular sieve by weight and from about 5% to about 12% binder by weight.

27. The device of claim 16, further comprising wire leads connected to the screening and configured to allow the adsorption bed to be heated by connecting an electrical power source to the leads.

28. The device of claim 16, further comprising spacers between adjacent layers of screening to fix the screen-to-screen spacing.

29. An device suitable for use in a vehicle exhaust system, comprising:
an adsorption or catalyst bed comprising an adsorbant or catalyst in a monolith structure, the monolith having walls defining an array of parallel passages;
wherein the walls have a void volume of at least about 0.1 exclusive of pores having a diameter less the 1 μm.

30. The device of claim 29, wherein the bed comprises at least about 20% adsorbant by volume.

31. The device of claim 30, wherein the adsorbant is a molecular sieve.

32. The device of claim 29, wherein the walls comprises at least about 40% adsorbant by weight.

33. The device of claim 32, wherein the walls comprises at least about 80% adsorbant by weight.

34. The device of claim 32, wherein the adsorbant is a molecular sieve.

35. The device of claim 29, wherein the walls are formed by sintering discrete pellets to form a cohesive structure.

36. The device of claim 29, wherein the walls are formed of discrete pellets held together by a binder.

37. The device of claim 36, wherein the pellets have a mass average effective diameter of at least about 1 mm.

38. The device of claim 29, wherein the monolith is permeated by metal wires that can be used to electrically heat the monolith.

39. The device of claim 29, wherein the monolith is permeated by tubes that can be used to heat the monolith through fluid heat exchange.

40. The device of claim 29, wherein the monolith comprises a metal substrate and wire leads adapted to connect an electrical power source to the monolith to heat the monolith.

41. A vehicle powered by an internal combustion engine comprising a device according to claim 29.

42. The device of claim 29, wherein the walls comprise at least about 70% a molecular sieve by weight and from about 1% to about 20% binder by weight.

43. The device of claim 42, wherein the walls comprise at least about 80% a molecular sieve by weight and from about 5% to about 12% binder by weight.

44. A device suitable for use in a vehicle exhaust system, comprising:
an adsorption or catalyst bed contained in a housing; and
an entrance port and an exit port configured with respect to the bed and housing such that gas under pressure drop between the entrance port and the exit port is channeled through the bed;
one or more channels passing through the bed but in fluid isolation from the adsorption bed, the channels individually having a cross-sectional area of at least about 1 square inch;
wherein there are a maximum of five of the channels within the housing.

45. The device of claim 44, wherein the cross-sectional area of the adsorption bed is no greater than about 50 square inches.

46. The device of claim 44, wherein the cross-sectional area of the adsorption bed is no greater than about 10 square inches.

47. The device of claim 44, wherein the device comprises only one of the channels.

48. A method of heating the device of claim 44 in a vehicle exhaust treatment system, comprising passing hot exhaust through the one or more channels.

49. A method of cooling the device of claim 44 in a vehicle exhaust treatment system, comprising passing ambient air through the one or more channels.

50. The device of claim 44, wherein the bed comprises screening.

51. The device of claim 50, wherein the bed comprises wire screens arrayed radially about one of the channels with edges of the screens being adjacent the channel.

52. The device of claim 51, wherein the screens curve along there lengths away from the channel, whereby the spacing between screens increases with distance from the central channel to a substantially lesser extent than would be the case for non-curving screens.

53. The device of claim 51, further comprising spacers between the screens positioned in such a manner that the spacers fix the screen-to-screen spacing.
